(19) United States
(12) Patent Application Publication
(10) Pub. No.: US 2026/0279618 A1
(43) Pub. Date: Sep. 17, 2026

(54) WIRE HARNESS

(71) Applicant: SUMITOMO WIRING SYSTEMS, LTD., Yokkaichi-shi, Mie (JP)

(72) Inventors: Hiroki YAMANOUCHI, Yokkaichi-shi (JP); Takuji IWAMA, Yokkaichi-shi (JP)

(73) Assignee: SUMITOMO WIRING SYSTEMS, LTD., Yokkaichi-shi, Mie (JP)

(21) Appl. No.: 18/872,527

(22) PCT Filed: May 29, 2023
(86) PCT No.: PCT/JP2023/019956

§ 371 Date: Dec. 6, 2024

(30) Foreign Application Priority Data
Jun. 10, 2022 (JP) 2022-094226

(51) Int. Cl. H01B 7/00; B60R 16/02; H02G 3/04

(52) U.S. Cl. CPC H01B 7/0045; B60R 16/0207; H02G 3/0481

(57) ABSTRACT

A wire harness including: an electric wire that includes a core wire and an insulating coating that covers the core wire; a protective cover that covers a periphery of the insulating coating; and a tube through which the electric wire is passed and that includes a bend, wherein: the protective cover and the insulating coating are integrally formed, and a portion of the insulating coating at a position corresponding to the bend has an increased thickness and functions as the protective cover.

### BACKGROUND

The present disclosure relates to a wire harness.

Some conventional wire harnesses to be mounted underneath the floor of a vehicle are produced by bending a pipe through which an electric wire is passed, into a predetermined shape. Some wire harnesses include an electric wire formed by connecting a plurality of electric wires, and a tube for covering a connection portion where the electric wires are connected (see JP 2020-161242A, for example).

### SUMMARY

In the wire harnesses as described above, for production reasons, the electric wire is likely to come into contact with the inner bend side of the bent portion of the pipe. In addition, while a vehicle is traveling, the temperature in the vicinity of the lower side of the floor, underneath which the wire harness is mounted, is likely to rise. Accordingly, when vibrations are conducted from the vehicle body to the wire harness in the state in which the electric wire is in contact with the pipe, the thickness of the covering material that covers the core wire of the electric wire is likely to decrease. As a result, the insulation reliability of the wire harness may decrease. The tube described in JP 2020-161242A above is provided for the purpose of imparting favorable water sealing properties to the connection portion, and the aforementioned problem is not solved thereby.

An exemplary aspect of the invention provides a wire harness capable of protecting an electric wire member passed through a tubular member.

A wire harness of the present disclosure includes: an electric wire that includes a core wire and an insulating coating that covers the core wire; a protective cover that covers a periphery of the insulating coating; and a tube through which the electric wire is passed and that includes a bend, wherein the protective cover is provided on the electric wire at a position corresponding to the bend.

The wire harness of the present disclosure exhibits an effect of protecting an electric wire passed through a pipe.

### BRIEF DESCRIPTION OF THE DRAWINGS

FIG. 1 is a schematic configuration diagram illustrating a wire harness of an embodiment.

FIG. 2 is a schematic cross-sectional view illustrating the wire harness of the embodiment.

FIG. 3 is a schematic transverse cross-sectional view illustrating the wire harness of the embodiment (a cross-sectional view taken along line 3-3 in FIG. 2).

FIG. 4 is a schematic transverse cross sectional view illustrating a wire harness of Modified Example 1.

FIG. 5 is a schematic cross sectional view illustrating a wire harness of Modified Example 2.

FIG. 6 is a schematic transverse cross-sectional view illustrating the wire harness of Modified Example 2 (a cross-sectional view taken along line 6-6 in FIG. 5).

FIG. 7 is a schematic cross sectional view illustrating a wire harness of Modified Example 3.

FIG. 8 is a schematic configuration diagram illustrating a wire harness of Modified Example 4.

FIG. 9 is a schematic cross-sectional view illustrating the wire harness of Modified Example 4.

FIG. 10 is a schematic transverse cross sectional view illustrating the wire harness of Modified Example 4 (a cross sectional view taken along line 10-10 in FIG. 9).

FIG. 11 is a schematic side view illustrating a wire harness of a comparative example.

FIG. 12 is a schematic transverse cross-sectional view illustrating the wire harness of the comparative example (a cross sectional view taken along line 12-12 in FIG. 11).

### DETAILED DESCRIPTION OF EMBODIMENTS

### Description of Embodiments of the Present Disclosure

First, embodiments of the present disclosure will be listed and described.
[1] A wire harness of the present disclosure includes: an electric wire member constituted of a core wire and an insulating coating covering the core wire; a protective member covering a periphery of the insulating coating; and a tubular member through which the electric wire member is passed and that includes a bent portion, wherein the protective member is provided on the electric wire member at a position corresponding to the bent portion. With this configuration, the protective member makes it unlikely that the electric wire member will come into contact with the inner bend side of the bent portion of the tubular member, thus making it possible to protect the electric wire member.
[2] In [1] above, a thermal expansion coefficient of the protective member is equal to a thermal expansion coefficient of the insulating coating. With this configuration, the protective member and the insulating coating of the electric wire member have the same thermal expansion coefficient, thus making it possible to suppress breakage of the insulating coating caused by a difference in the thermal expansion coefficient between the protective member and the insulating coating.
[3] In [1] or [2] above, the electric wire member is one of a plurality of electric wire members, the plurality of electric wire members are passed through the tubular member, and the protective member bundles the plurality of electric wire members. With this configuration, the protective member bundles the plurality of electric wire members, thus making it possible to easily pass the plurality of electric wire members through the tubular member.
[4] In [1] or [2] above, the electric wire member is one of a plurality of electric wire members, the plurality of electric wire members are passed through the tubular member, and the protective member covers a periphery of the insulating coating of at least the electric wire member closest to an inner bend side of the bent portion out of the plurality of electric wire members. With this configuration, the protective member can protect the electric wire member that is likely to come into contact with the tubular member.
[5] In [1] or [2] above, the electric wire member is one of a plurality of electric wire members, the plurality of electric wire members are passed through the tubular member, and the protective member covers a periphery of the insulating coating of each of the plurality of electric wire members. With this configuration, the protective member can protect the insulating coating of each of the plurality of electric wire members individually. Accordingly, it is possible to absorb a difference in curvature between the electric wire member near the inner bend side of the bent portion of the tubular member and the electric wire member near the outer side thereof.

### Details of Embodiments of the Present Disclosure

The following describes specific examples of a wire harness of the present disclosure with reference to the drawings. A portion of the configuration may be exaggerated or simplified for illustrative purposes in the diagrams. In addition, the ratios between the dimensions of portions shown in the diagrams may be different from each other. The terms “parallel” and “orthogonal” as used herein encompass not only “precisely parallel” and “precisely orthogonal” but also “substantially parallel” and “substantially orthogonal”, as long as the functions and effects of these embodiments are exhibited. Note that the present disclosure is not limited to these examples and is defined by the scope of the appended claims, and all changes that fall within the same essential spirit as the scope of the claims are intended to be included therein.

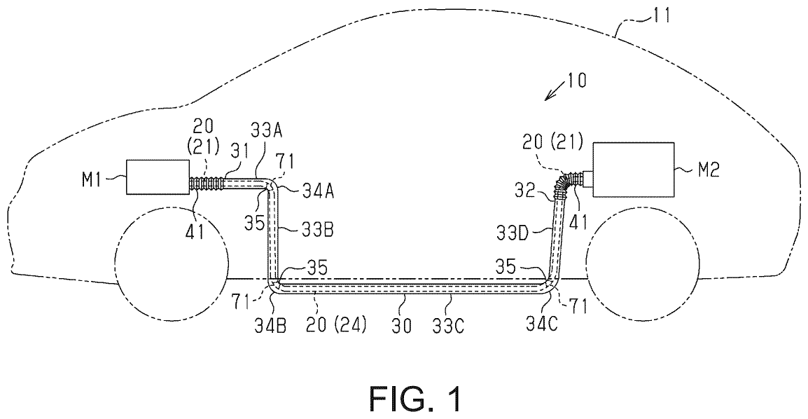

Hereinafter, an embodiment of a wire harness 10 will be described with reference to FIGS. 1 to 3.

### Overall Configuration of Wire Harness 10

As shown in FIG. 1, the wire harness 10 electrically connects electric apparatuses M1 and M2. Note that the wire harness 10 may also be configured to connect three or more electric apparatuses.

The wire harness 10 is mounted, for example, in a vehicle 11 such as a hybrid car or an electric car. The wire harness 10 includes one or more electric wire members 20 (electric wires) (two electric wire members in this embodiment) that electrically connect the electric apparatus MI and the electric apparatus M2. The wire harness 10 includes, for example, a tubular member 30 (tube) through which the plurality of electric wire members 20 pass, and a tubular exterior member 41 that surrounds the portions of the electric wire members 20 extending from the tubular member 30. The tubular member 30 and the exterior member 41 protect the electric wire members 20 housed therein from flying objects and waterdrops. The wire harness 10 has, for example, a path that is bent two dimensionally or three-dimensionally.

### Configuration of Electric Wire Member 20

For example, the wire harness 10 is routed from the electric apparatus M1 to the electric apparatus M2 while a portion in the longitudinal direction thereof is passing underneath the floor of the vehicle 11. One end portion of each electric wire member 20 is connected to the electric apparatus M1, and the other end portion of each electric wire member 20 is connected to the electric apparatus M2. An example of the electric apparatus M1 is an inverter that is provided in the front portion of the vehicle 11, and an example of the electric apparatus M2 is a high-voltage battery that is provided on the rear side of the vehicle 11 relative to the electric apparatus M1. The inverter is connected to, for example, a wheel driving motor that serves as a power source for vehicle travel. The inverter generates AC power from DC power supplied from the high voltage battery and supplies the AC power to the motor. The high voltage battery can supply, for example, a voltage of a hundred volts or more.

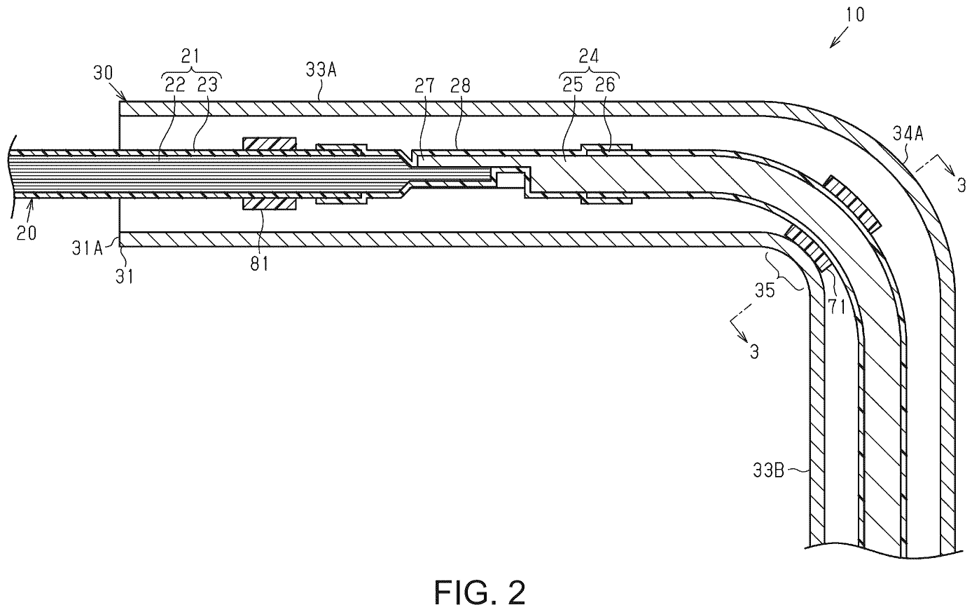

As shown in FIG. 2, each electric wire member 20 includes a first electric wire 21, and a second electric wire 24 that is electrically connected to the first electric wire 21. For example, the first electric wire 21 is a flexible electric wire, and the second electric wire 24 is a hard electric wire. That is to say, in this embodiment, each electric wire member 20 is formed by electrically connecting the first electric wire 21 and the second electric wire 24, which are different types of electric wires, in the longitudinal direction of the electric wire member 20. Note that the electric wire member 20 may also be formed by electrically connecting a first electric wire 21 and a second electric wire 24 that are the same type of electric wire. The flexible electric wire is more flexible than the hard electric wire. The flexible electric wire has higher bendability than the hard electric wire. The hard electric wire has, for example, higher flexural rigidity than the flexible electric wire. The hard electric wire has, for example, such rigidity that enables the hard electric wire to keep a shape extending along the wiring path of the electric wire member 20. For example, the hard electric wire has rigidity to an extent that its linear shape or bent shape is not changed due to vibrations of the vehicle 11 or the like in a state in which the hard electric wire is mounted in the vehicle 11 (see FIG. 1). For example, when being routed along a curved path, the hard electric wire is bent, and its bent shape is maintained.

As shown in FIGS. 1 and 2, each electric wire member 20 includes a connection portion 27 where the first electric wire 21 and the second electric wire 24 are joined to each other, and a covering member 28 that covers the outer periphery of the connection portion 27. The first electric wire 21 is connected to each of the two end portions of the second electric wire 24 in the longitudinal direction. In this embodiment, the intermediate portion of each electric wire member 20 in the longitudinal direction is constituted of the second electric wire 24, and both end portions of each electric wire member 20 in the longitudinal direction are constituted of the first electric wire 21. The first electric wire 21 and the second electric wire 24 are, for example, high-voltage electric wires to which a high voltage/a large current can be applied. The first electric wire 21 and the second electric wire 24 may each be, for example, a shielded electric wire having an electromagnetic shielding structure, or a non shielded electric wire having no electromagnetic shielding structure. The first electric wire 21 and the second electric wire 24 of this embodiment are non shielded electric wires.

### Configuration of First Electric Wire 21

As shown in FIG. 2, the first electric wire 21 includes a core wire 22 constituted of a plurality of metal strands, and an insulating coating 23 that covers the outer circumference of the core wire 22. Examples of the core wire 22 include a stranded wire formed by twisting a plurality of metal strands together, and a braided member formed by braiding a plurality of metal strands into a tubular shape. The core wire 22 of this embodiment is a stranded wire. Examples of the material of the core wire 22 include metal materials such as copper-based materials and aluminum-based materials.

The shape of the cross section of the core wire 22 taken along a plane orthogonal to the longitudinal direction of the core wire 22, namely the transverse cross sectional shape of the core wire 22, may be a desired shape. The transverse cross sectional shape of the core wire 22 may be, for example, a circular shape, a semicircular shape, a polygonal shape, a square shape, or a flat shape. The transverse cross-sectional shape of the core wire 22 of this embodiment is a circular shape.

The insulating coating 23 covers, for example, the outer circumferential surface of the core wire 22 over the entire circumference in the circumferential direction thereof. The insulating coating 23 is made of, for example, an insulating material such as a synthetic resin. Examples of the material of the insulating coating 23 include polyolefin-based resins such as cross-linked polyethylene and cross-linked polypropylene. For example, the insulating coating 23 can be formed on the core wire 22 through extrusion molding (extrusion coating). The thickness of the insulating coating 23 is, for example, 1.4 mm.

### Configuration of Second Electric Wire 24

The second electric wire 24 includes, for example, a core wire 25 constituted of a single conductor, and an insulating coating 26 that covers the outer circumference of the core wire 25. Examples of the core wire 25 include a columnar conductor constituted of a single columnar metal rod having a solid structure, and a tubular conductor having a hollow structure. The core wire 25 of this embodiment is a columnar conductor. Examples of the material of the core wire 25 include metal materials such as copper based materials and aluminum-based materials. The material of the core wire 25 may be, for example, the same type of material as the material of the core wire 22 or a material different from the material of the core wire 22. The core wire 25 is formed through, for example, extrusion molding. The transverse cross sectional shape of the core wire 25 may be a desired shape. The transverse cross-sectional shape of the core wire 25 of this embodiment is a circular shape.

The insulating coating 26 covers, for example, the outer circumferential surface of the core wire 25 over the entire circumference in the circumferential direction thereof. The insulating coating 26 is made of, for example, an insulating material such as a synthetic resin. Examples of the material of the insulating coating 26 include polyolefin-based resins such as cross-linked polyethylene and cross-linked polypropylene. For example, the insulating coating 26 can be formed on the core wire 25 through extrusion molding. For example, a heat shrinkable tube or a rubber tube can also be used as the insulating coating 26. The thickness of the insulating coating 26 is, for example, 1.1 mm.

### Configuration of Connection Portion 27

The core wire 22 and the core wire 25 are joined to each other at the connection portion 27. Specifically, at an end portion of the first electric wire 21 in the longitudinal direction, the insulating coating 23 of a predetermined length from the terminus of the first electric wire 21 is removed, and the end portion of the core wire 22 is exposed. At an end portion of the second electric wire 24 in the longitudinal direction, the insulating coating 26 of a predetermined length from the terminus of the second electric wire 24 is removed, and the end portion of the core wire 25 is exposed. At the connection portion 27, the end portion of the core wire 22 exposed from the insulating coating 23 is joined to the end portion of the core wire 25 exposed from the insulating coating 26. For example, at the connection portion 27, the core wire 22 and the core wire 25 are stacked in the radial direction, namely a direction that intersects the longitudinal direction of the core wire 22 and the core wire 25, and are joined to each other. Note that there is no particular limitation on the method of connecting the core wire 22 and the core wire 25. Examples of the method of connecting the core wire 22 and the core wire 25 include supersonic welding and laser welding.

### Configuration of Covering Member 28

The covering member 28 covers the outer periphery of the connection portion 27. The covering member 28 is formed, for example, in an elongated tubular shape. The covering member 28 covers, for example, the core wire 22 exposed from the insulating coating 23 and the core wire 25 exposed from the insulating coating 26. For example, the covering member 28 spans the end portion of the insulating coating 23 and the end portion of the insulating coating 26. For example, one end portion of the covering member 28 covers the outer circumferential surface of the end portion of the insulating coating 23, and the other end portion of the covering member 28 covers the outer circumferential surface of the end portion of the insulating coating 26. The covering member 28 surrounds the outer circumference of the first electric wire 21 and the outer circumference of the second electric wire 24 over the entire circumference in the circumferential direction thereof. The covering member 28 has, for example, a function of keeping the connection portion 27 and the core wires 22 and 25 exposed from the insulating coatings 23 and 26 electrically insulated. The covering member 28 has, for example, a function of keeping the connection portion 27 and the core wires 22 and 25 exposed from the insulating coatings 23 and 26 waterproof.

Examples of the covering member 28 include a shrinkable tube, a rubber tube, a resin mold, a hot melt adhesive, and a tape member. The covering member 28 of this embodiment is a heat shrinkable tube. Examples of the material of the covering member 28 include synthetic resins containing a polyolefin-based resin such as cross-linked polyethylene and cross-linked polypropylene as a main component. The thickness of the covering member 28 is, for example, 1.1 mm.

Here, the second electric wire 24 is provided, for example, inside the tubular member 30. For example, the tubular member 30 surrounds the second electric wire 24 over the entire length in the longitudinal direction of the second electric wire 24. The connection portion 27 is provided, for example, inside the tubular member 30. For example, an end portion of the first electric wire 21 in the longitudinal direction is provided inside the tubular member 30. The first electric wire 21 extends to the outside of the tubular member 30 beyond an end portion 31 of the tubular member 30. Although not illustrated, at an end portion 32 (see FIG. 1) of the tubular member 30 as well, the connection portion 27 where an end portion of the first electric wire 21 in the longitudinal direction is connected to an end portion of the second electric wire 24 in the longitudinal direction is provided inside the tubular member 30. The first electric wire 21 extends to the outside of the tubular member 30 beyond the end portion 32 of the tubular member 30.

### Configuration of Tubular Member 30

The tubular member 30 of this embodiment is formed in an elongated cylindrical shape. The tubular member 30 is provided, for example, at the intermediate portion of the wire harness 10 in the longitudinal direction. For example, the intermediate portions of the electric wire members 20 in the longitudinal direction are housed inside the tubular member 30. The tubular member 30 surrounds, for example, the outer circumferences of the electric wire members 20 over the entire circumference in the circumferential direction thereof. Examples of the tubular member 30 include a metal pipe, a resin pipe, a resin corrugated tube, a rubber waterproof cover, and combinations thereof. Examples of the material of the metal pipe include metal materials such as aluminum-based materials and copper-based materials. Examples of the material of the resin pipe and the resin corrugated tube include resin materials having electrical conductivity and resin materials having no electrical conductivity. Examples of the resin materials include synthetic resins such as polyolefins, polyamides, polyesters, and ABS resins. The tubular member 30 of this embodiment is a metal pipe.

As shown in FIG. 1, the tubular member 30 is bent, for example, two-dimensionally or three-dimensionally. The tubular member 30 includes a linear portion 33A that is located at the end portion 31 and extends linearly in the vehicle front-rear direction, a bent portion 34A (bend) that is provided at one end portion of the linear portion 33A, and a linear portion 33B that extends downward from the bent portion 34A in the vehicle vertical direction. Also, the tubular member 30 includes a bent portion 34B provided at one end portion of the linear portion 33B, and a linear portion 33C that extends rearward from the bent portion 34B in the vehicle front-rear direction. Furthermore, the tubular member 30 includes a bent portion 34C provided at one end portion of the linear portion 33C, and a linear portion 33D that extends upward from the bent portion 34C in the vehicle vertical direction.

For example, the wire harness 10 is produced as follows. First, the electric wire members 20 in a linear shape are inserted into the tubular member 30 in a linear shape. Then, the tubular member 30 is bent in a state in which the electric wire members 20 are inserted. Thereby, the bent portions 34A, 34B, and 34C are formed at a plurality of positions of the tubular member 30. At this time, the tubular member 30 and the electric wire members 20 inserted into the tubular member 30 are simultaneously bent. Also, in the case of the wire harness 10 of this embodiment, the bending process is started at the closest position to the end portion 31 of the tubular member 30. The bending process is sequentially performed from a position close to the end portion 31 toward a position close to the end portion 32 at a plurality of positions of the tubular member 30. That is to say, when the tubular member 30 is bent, the bent portions 34A, 34B, and 34C are formed in this order. Note that the bent portion 34A is the closest to the end portion 31 out of the plurality of bent portions 34A, 34B, and 34C.

As shown in FIG. 2, the linear portions 33A and 33B are respectively continuous with both sides of the bent portion 34A. The bent portion 34A is bent, for example, at a right angle. For example, the bent portion 34A is bent such that the direction in which the central axis of the linear portion 33A extends is orthogonal to the direction in which the central axis of the linear portion 33B extends. The bent portion 34A includes an inner bend side 35. Portions of the electric wire members 20 located inside the bent portion 34A are bent along the bent portion 34A.

The linear portion 33A is provided between an end surface 31A at the end portion 31 of the tubular member 30 in the longitudinal direction and the bent portion 34A. For example, the connection portions 27 of the electric wire members 20 are located inside the linear portion 33A.

### Configurations of Exterior Member 41

As shown in FIG. 1, the exterior member 41 has an elongated tubular shape. The exterior member 41 is provided, for example, at both end portions of the wire harness 10 in the longitudinal direction. For example, end portions of the electric wire members 20 in the longitudinal direction, namely end portions of the electric wire members 20 extending from the tubular member 30, are housed inside the exterior member 41. The exterior member 41 surrounds, for example, the outer circumferences of the electric wire members 20 over the entire circumference in the circumferential direction thereof. The exterior member 41 surrounds, for example, the outer circumferences of the first electric wires 21 extending in the longitudinal direction of the electric wire members 20 over the entire circumference in the circumferential direction thereof. Examples of the exterior member 41 include a corrugated tube and a waterproof cover.

### Configuration of Protective Member 71

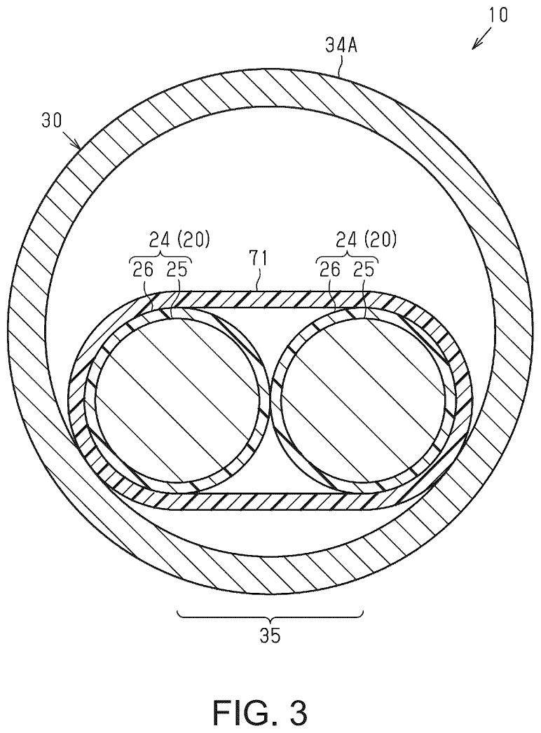

As shown in FIGS. 1 to 3, the wire harness 10 includes protective members 71 (protective covers). Each of the protective member 71 surrounds the outer circumferences of the two electric wire members 20. The protective members 71 are provided at predetermined positions in the longitudinal direction of the tubular member 30. The protective members 71 are provided at positions corresponding to the bent portions 34A to 34C of the tubular member 30. As shown in FIGS. 2 and 3, the protective member 71 is provided inside the bent portion 34A of the tubular member 30. The protective member 71 bundles the two electric wire members 20. In this embodiment, the protective member 71 bundles the second electric wires 24 included in the electric wire members 20.

The protective members 71 are in contact with the inner bend sides 35 of the bent portions 34A to 34C. Each of the protective members 71 is made of, for example, an insulating material such as a synthetic resin. The thermal expansion coefficient of the protective member 71 is equal to the thermal expansion coefficient of the insulating coating 26 of the second electric wire 24. Here, when the insulating coating 26 and the protective member 71, which are in contact with each other, expand and shrink in response to heat but this does not cause deformation or the like of the insulating coating 26, it can be considered that “the thermal expansion coefficients are equal to each other”. Examples of the material of the protective member 71 include polyolefin-based resins such as cross-linked polyethylene and cross-linked polypropylene. For example, a heat-shrinkable tube or a rubber tube can also be used as the protective member 71. The thickness of the protective member 71 is, for example, 1.0 mm.

### Configuration of Fixing Member 81

As shown in FIG. 2, the wire harness 10 includes a fixing member 81.

The fixing member 81 bundles a plurality of electric wire members 20. In this embodiment, the fixing member 81 bundles the first electric wires 21 of the electric wire members 20. The fixing member 81 is made of the same material as the material of the protective member 71. Note that the fixing member 81 may be omitted. Instead of the fixing member 81, the protective member 71 may also bundle the first electric wires 21.

### Functions and Effects

As described above, with this embodiment, the following functions and effects are exhibited.
(1) The wire harness 10 includes the electric wire members 20 that each include the second electric wire 24 constituted of the core wire 25 and the insulating coating 26 covering the core wire 25, the protective members 71 covering the periphery of the insulating coating 26, and the tubular member 30 through which the electric wire members 20 are passed and that includes the bent portions 34A to 34C. The protective members 71 are provided on the second electric wire 24 of the electric wire member 20 at positions corresponding to the bent portions 34A to 34C.

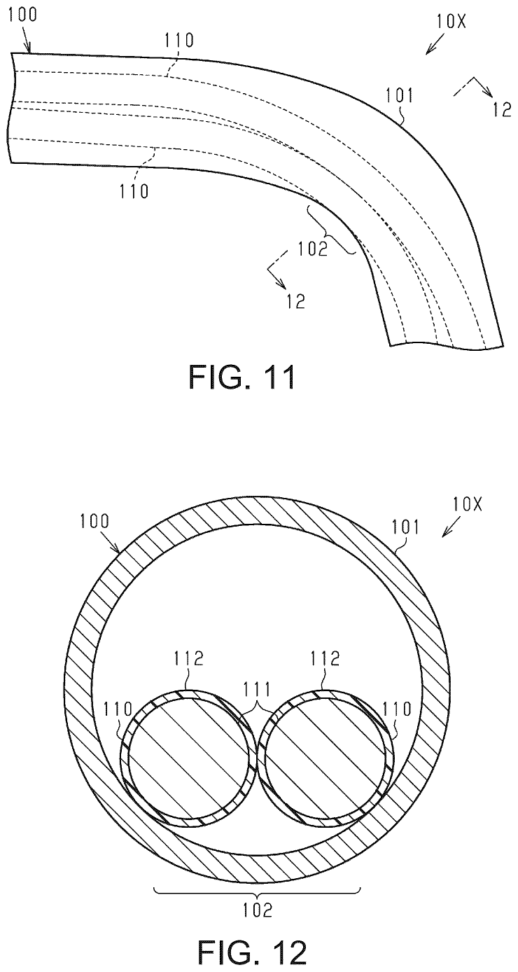

FIGS. 11 and 12 illustrate a wire harness 10X of a comparative example. In the wire harness 10X of the comparative example, a plurality of electric wires 110 inserted into a tubular member 100 are bent together. As a result, the electric wires 110 come into contact with the inner circumferential surface of the tubular member 100 at an inner bent part 102 of a bent portion 101 of the tubular member 100. In this state, the temperature underneath the floor of the vehicle 11 is transmitted to the insulating coatings 112 of the electric wires 110 via the tubular member 30. When vibrations are then conducted from the vehicle 11 to the wire harness 10X in the state in which the electric wires 110 are in contact with the tubular member 30, the thicknesses of the insulating coatings 112 each covering a core wire 111 of the electric wire 110 are likely to decrease.

The protective members 71 of the wire harness 10 of this embodiment are provided on the electric wire members 20 at positions corresponding to the bent portions 34A to 34C. Therefore, the insulating coatings 26 are unlikely to come into contact with the inner bend sides 35 of the bent portions 34A to 34C of the tubular member 30. Accordingly, a decrease in the thickness of the insulating coating 26 can be suppressed. As a result, the electric wire members 20 (second electric wires 24) can be protected. Thus, a decrease in reliability of the wire harness 10 can be suppressed.
(2) The thermal expansion coefficient of the protective member 71 is equal to the thermal expansion coefficient of the insulating coating 26. The insulating coating 26 of the second electric wire 24 of the electric wire member 20 and the protective member 71 expand and shrink in response to a change in temperature at a portion on which the wire harness 10 is installed. At this time, the insulating coating 26 and the protective member 71 have the same thermal expansion coefficient, thus making it possible to suppress breakage of the insulating coating 26 caused by a difference in the thermal expansion coefficient between the protective member 71 and the insulating coating 26.
(3) Two electric wire members 20 are passed through the tubular member 30. The protective members 71 bundle the two electric wire members 20. Therefore, the two electric wire members 20 can be easily passed through the tubular member 30.

### Other Embodiments

The embodiment mentioned above can be implemented with modifications as follows. The embodiment mentioned above and the following modified examples can be implemented in combination with each other as long as they are technically compatible with each other.
The configuration of the wire harness 10 of the embodiment above may be changed as appropriate.

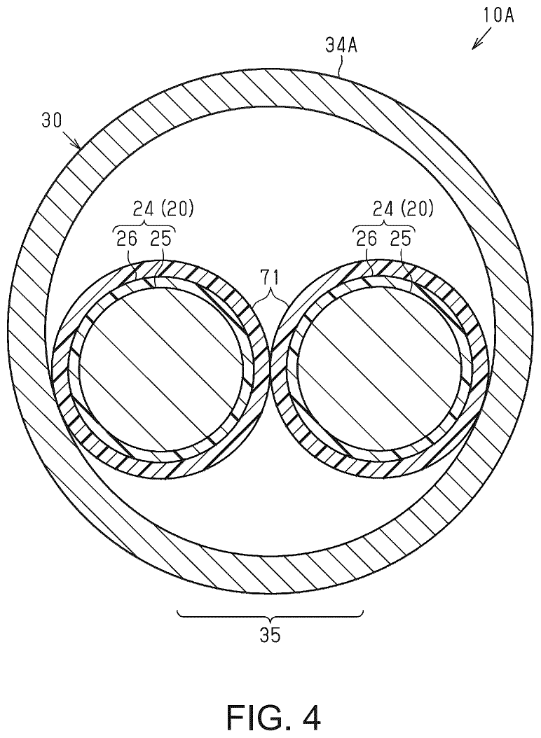

As in the case of a wire harness 10A of Modified Example 1 shown in FIG. 4, a configuration may also be employed in which the protective members 71 that cover the respective insulating coatings 26 of the second electric wires 24 of the electric wire members 20 are included.

With this configuration, the protective member 71 can protect each of the insulating coatings 26 of the second electric wires 24 of the plurality of electric wire members 20 individually. Accordingly, it is possible to absorb a difference in curvature between the electric wire on the inner side and the electric wire on the outer side at the bent portion 34A of the tubular member 30. That is to say, even when the plurality of second electric wires 24 are bent with different curvatures, the second electric wires 24 are respectively protected by the protective members 71, thus making it possible to favorably bend the second electric wires 24.

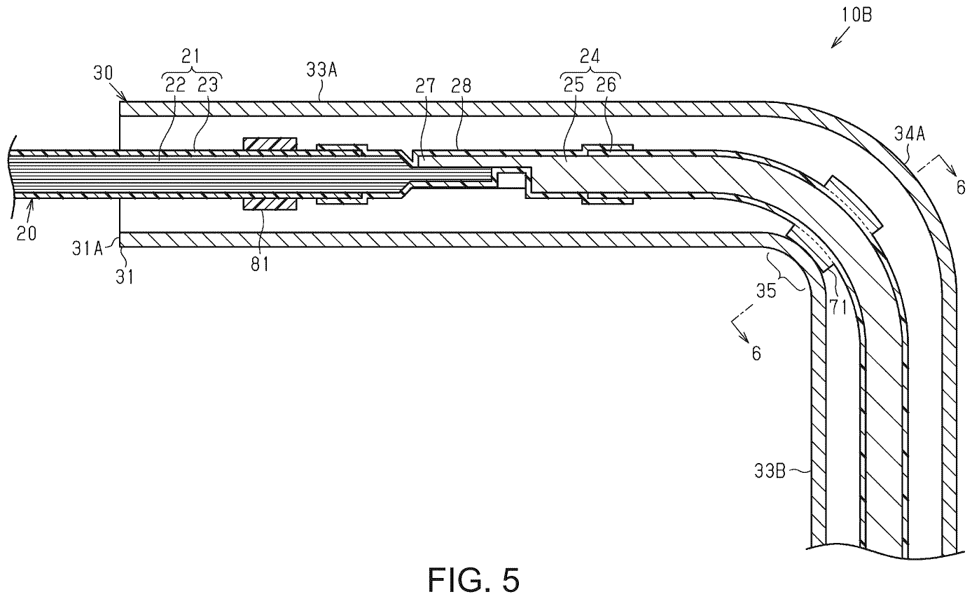

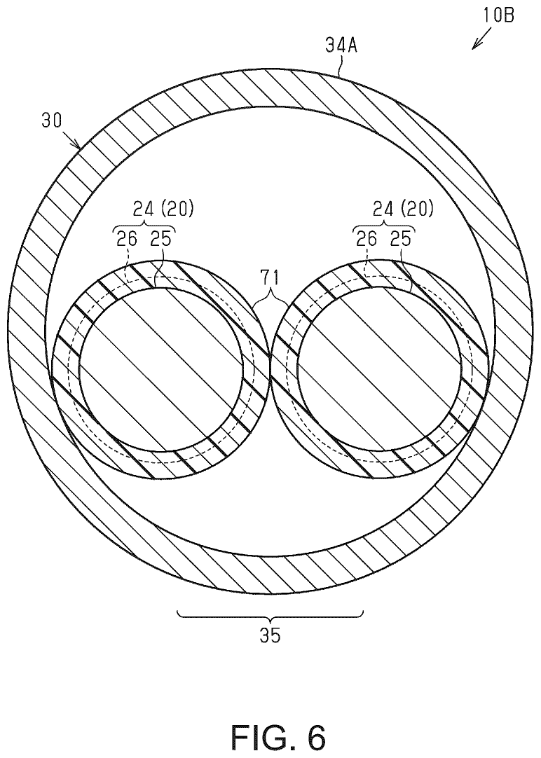

As in the case of a wire harness 10B of Modified Example 2 shown in FIGS. 5 and 6, each of the insulating coatings 26 of the second electric wires 24 of the electric wire members 20 may be integrated with the protective member 71. That is to say, the portions of the insulating coating 26 corresponding to the bent portions 34A to 34C may have an increased thickness, and the thick portions of the insulating coating 26 may function as the protective member 71 covering the periphery of the insulating coating 26. However, the insulating coating 26 and the protective member 71 need not be made of the same material as long as they are integrally formed. In FIGS. 5 and 6, broken lines indicate a boundary between the insulating coating 26 and the protective member 71 as a matter of convenience. Actually, the boundary may disappear or be unclear.

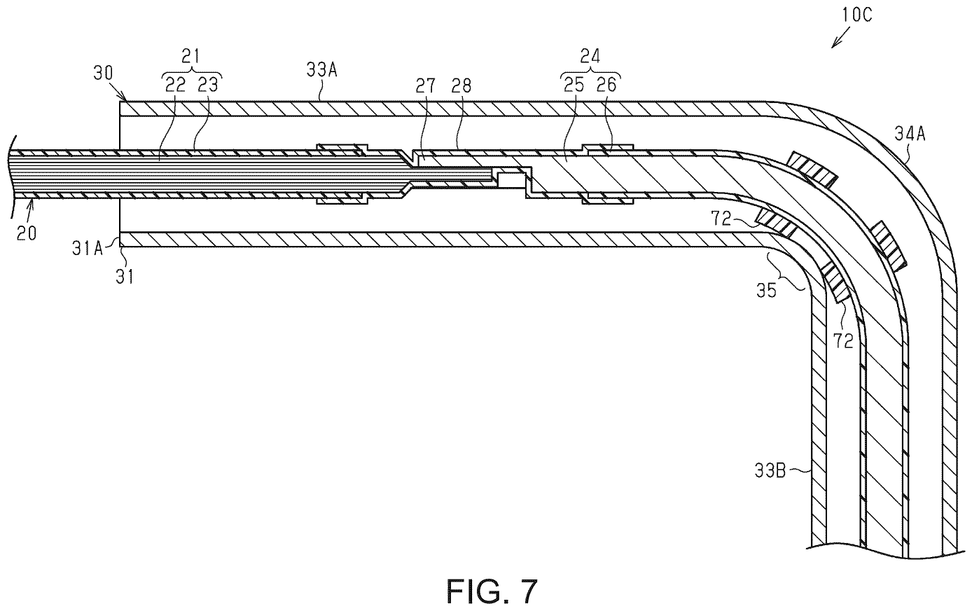

As in the case of a wire harness 10C of Modified Example 3 shown in FIG. 7, protective members 72 may be provided at positions corresponding to the positions on both sides of the bent portion 34A of the tubular member 30.

Disposing the protective members 72 in this manner makes it possible to more favorably suppress contact of the insulating coatings 26 of the second electric wires 24 of the electric wire members 20 with the inner bend side 35 of the bent portion 34A of the tubular member 30.

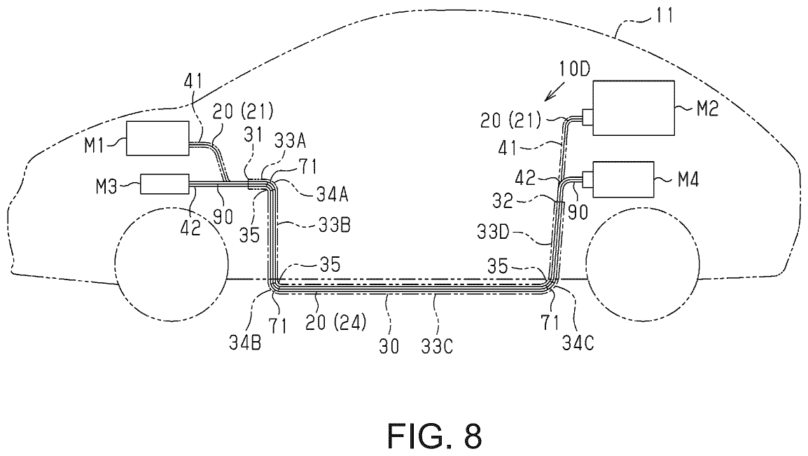

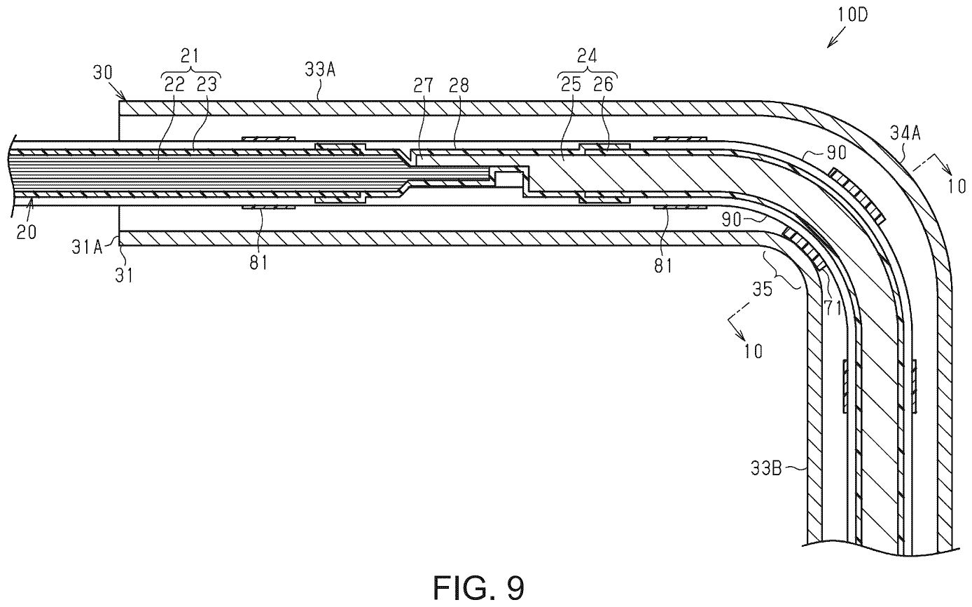

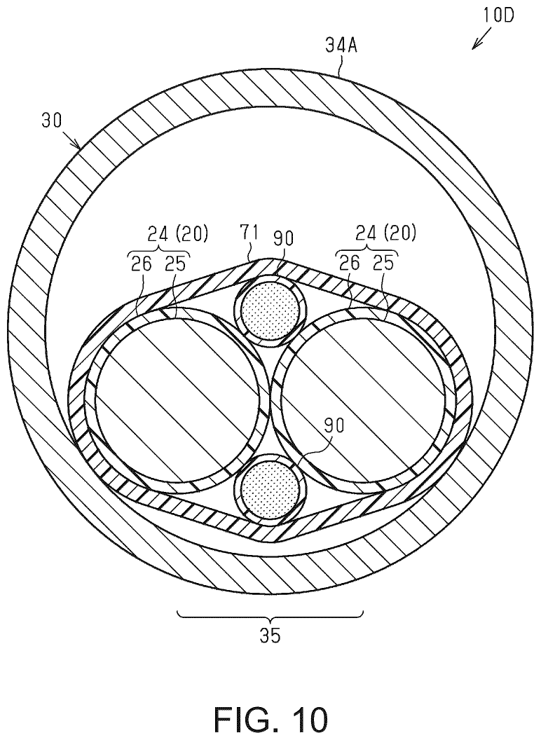

A wire harness 10D of Modified Example 4 shown in FIGS. 8 to 10 connects electric apparatuses M1 to M4 mounted on the vehicle 11. The electric apparatus M3 is, for example, a relay box that is installed in the front portion of the vehicle 11, and the electric apparatus M4 is, for example, a low voltage battery that is installed in the rear portion of the vehicle 11. The wire harness 10D includes electric wire members 90 for connecting the electric apparatuses M3 and M4. The electric wire members 90 are, for example, flexible electric wires. As shown in FIGS. 9 and 10, the protective member 71 bundles two electric wire members 20 and two electric wire members 90. In the wire harness 10D configured as described above, the protective member 71 can protect the electric wire members 20 and 90.
The embodiment above may also have a configuration in which the protective member 71 is provided on at least the electric wire member 20 (second electric wire 24) close to the inner bend sides 35 of the bent portions 34A to 34C of the tubular member 30 out of the plurality of electric wire members 20. In this case, the protective member can protect the electric wire that is likely to come into contact with the tubular member 30. The electric wire members 20 (second electric wires 24) can be protected using a protective member with a minimal size.
In the embodiment above, the protective member 71 covers the outer circumference of the insulating coating 26 of the second electric wire 24 of the electric wire member 20. However, it is sufficient that the insulating coating 26 is unlikely to come into contact with the bent portions 34A to 34C of the tubular member 30, and, for example, a configuration may also be employed in which the protective member 71 is provided on the inner bent part of the bent second electric wire 24 (electric wire member 20) and the outer bent part is not provided with the protective member 71. That is to say, it is sufficient that the protective member 71 is at least interposed between the inner bend side 35 of each of the bent portions 34A to 34C and the insulating coating 26 of the second electric wire 24. In the wire harness 10C of Modified Example 3 shown in FIG. 7, the protective members 72 are provided so as to be spaced apart from one another in the longitudinal direction of the electric wire member 20 (second electric wire 24), but the protective members 72 may be provided so as to be spaced apart from one another in the circumferential direction of the second electric wire 24.
In the embodiment above, the electric wire member 20 formed by connecting the first electric wire 21 and the second electric wire 24 is used. However, the electric wire member 20 may be constituted of only the first electric wire 21. Also, the electric wire member 20 may be constituted of only the second electric wire 24.
The present disclosure encompasses the following aspect. For the purpose of not limiting but merely facilitating understanding, the reference numerals for the constituent elements of the embodiment above are used.

### Supplementary Note 1

A wire harness (10; 10A; 10B; 10C; 10D) including: an electric wire (24) having a core wire (25) and an insulating coating (26) covering the core wire (25); a protective member (71; 72) covering the periphery of the insulating coating (26); and a tubular member (30) through which the electric wire (24) is passed and that includes a bent portion (34A: 34B; 34C), wherein the protective member (71; 72) is at least interposed between an inner bend side (35) of the bent portion (34A; 34B; 34C) and the insulating coating (26) of the electric wire (24).

1. A wire harness comprising:
an electric wire that includes a core wire and an insulating coating that covers the core wire;
a protective cover that covers a periphery of the insulating coating; and
a tube through which the electric wire is passed and that includes a bend, wherein:
the protective cover and the insulating coating are integrally formed, and
a portion of the insulating coating at a position corresponding to the bend has an increased thickness and functions as the protective cover.

2-3. (canceled)

4. The wire harness according to claim 1, wherein:
the electric wire is one of a plurality of electric wires,
the plurality of electric wires are passed through the tube, and
the protective cover covers a periphery of the insulating coating of at least an electric wire out of the plurality of electric wires closest to an inner bend side of the bend.

5. The wire harness according to claim 1, wherein:
the electric wire is one of a plurality of electric wires,
the plurality of electric wires are passed through the tube, and
the protective cover covers a periphery of the insulating coating of each electric wire of the plurality of electric wires.
